(19) United States
(12) Patent Application Publication
(10) Pub. No.: US 2025/0266634 A1
(43) Pub. Date: Aug. 21, 2025

(54) ELECTRICAL CONNECTOR FOR SUPPLYING UTILITY

(71) Applicant: UNITEST INC, Yongin-si (KR)

(72) Inventor: Hyun Sung LEE, Hwaseong-si (KR)

(73) Assignee: UNITEST INC, Yongin-si (KR)

(21) Appl. No.: 18/777,490

(22) Filed: Jul. 18, 2024

(30) Foreign Application Priority Data
Feb. 21, 2024 (KR) 10-2024-0024981

(51) Int. Cl. H01R 13/15; H01R 13/405; H01R 13/629

(52) U.S. Cl. CPC H01R 13/15; H01R 13/405; H01R 13/629

(57) ABSTRACT

Proposed is an electrical connector for supplying a utility. The electrical connector includes a first coupling member provided on any one of a utility supplying end or a utility receiving end, a first terminal provided on the first coupling member, a second coupling member provided on other one of the utility supplying end or the utility receiving end and configured to be coupled to the first coupling member, and a second terminal provided on the second coupling member and configured to be elastically in contact with the first terminal.

### CROSS REFERENCE TO RELATED APPLICATION

The present application claims priority to Korean Patent Application No. 10-2024-0024981, filed Feb. 21, 2024, the entire contents of which are incorporated herein for all purposes by this reference.

### BACKGROUND OF THE INVENTION

### Field of the Invention

The present disclosure relates to an electrical connector for supplying and maintaining a power utility (a signal).

### Description of the Related Art

Generally, various utilities such as air, nitrogen, vacuum, pure water (DW), power, and so on are required in a semiconductor manufacturing process, and it is very important to smoothly supply such utilities in the manufacturing process.

For example, in a packaging process of a semiconductor device, a unit semiconductor device is electrically tested after an assembly is completed by using a tester and a handler. The handler performs a mechanical operation by receiving an electrical signal, connects the semiconductor device to a contactor connected to the tester, and tests electrical characteristics of the semiconductor device. Furthermore, the handler classifies whether the semiconductor device is defective on the basis of the test result, and then unloads the semiconductor device to a semiconductor package carrier such as a tube or a tray.

### DOCUMENT OF RELATED ART

(Patent Document 1) Korean Patent Application Publication No. 10-1995-0006024 (published on Jun. 7, 1995)

### SUMMARY OF THE INVENTION

An objective of the present disclosure is to provide an electrical connector for connecting a power, a detection signal, or a control signal between a utility supplying end for supplying a utility and a utility receiving end in a manufacturing facility.

In order to achieve the objective of the present disclosure, there is provided an electrical connector for supplying a utility, the electrical connector including: a first coupling member provided on any one of a utility supplying end or a utility receiving end; a first terminal provided on the first coupling member; a second coupling member provided on other one of the utility supplying end or the utility receiving end and configured to be coupled to the first coupling member; and a second terminal provided on the second coupling member and configured to be elastically in contact with the first terminal.

Preferably, the second terminal may include: a housing fixed to the second coupling member; a terminal plate formed in a plate shape and figured to move back and forth within the housing in a coupling direction of the first coupling member and the second coupling member; and an elastic body elastically supporting the terminal plate the housing.

Preferably, the first terminal may include: a terminal mold fixed to the first coupling member; and a terminal bar fixed to the terminal mold.

Preferably, the first terminal and the second terminal may include: a power terminal unit for supplying power; and a signal terminal unit for inputting and outputting a detection signal of a sensor.

Preferably, the first coupling member and the second coupling member may further include respective coupling guide members for male-female coupling.

In the electrical connector for supplying the utility of the present disclosure, the electrical connector includes: the first coupling member provided on any one of the utility supplying end or the utility receiving end; the first terminal provided on the first coupling member; the second coupling member provided on other one of the utility supplying end or the utility receiving end and configured to be coupled to the first coupling member; and the second terminal provided on the second coupling member and configured to be elastically in contact with the first terminal. Therefore, there is an effect of stably supplying a power utility (a signal).

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 and FIG. 2 are perspective views respectively illustrating a separated state and a connected state of an electrical connector for supplying a utility according to an embodiment of the present disclosure;

FIG. 3 and FIG. 4 are perspective views illustrating only terminals of the electrical connector for supplying the utility according to an embodiment of the present disclosure; and

FIG. 5A and FIG. 5B are cross-sectional views illustrating an operation state of the electrical connector for supplying the utility according to an embodiment of the present disclosure.

### DETAILED DESCRIPTION OF THE INVENTION

Specific structures and functions stated in the following embodiments of the present disclosure are exemplified to illustrate embodiments according to the spirit of the present disclosure and the embodiments according to the spirit of the present disclosure can be achieved in various ways. Furthermore, the present disclosure should not be construed as being limited to the following embodiments and should be construed as including all changes, equivalents, and replacements included in the spirit and scope of the present disclosure.

Hereinafter, the present disclosure will be described in detail with reference to the accompanying drawings.

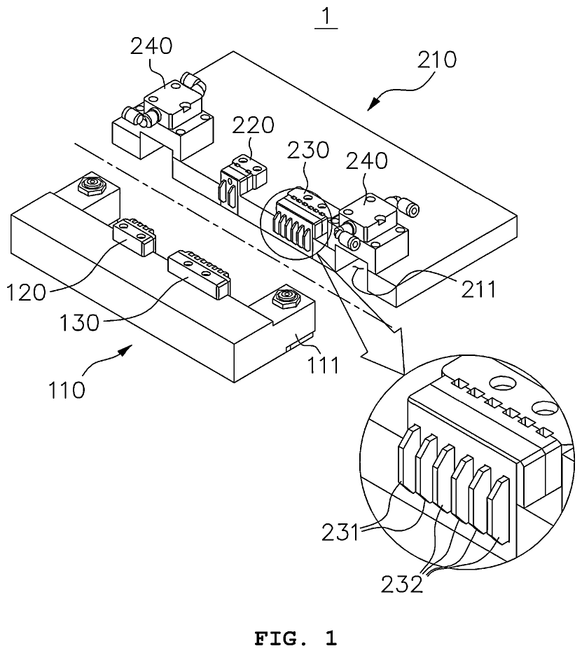

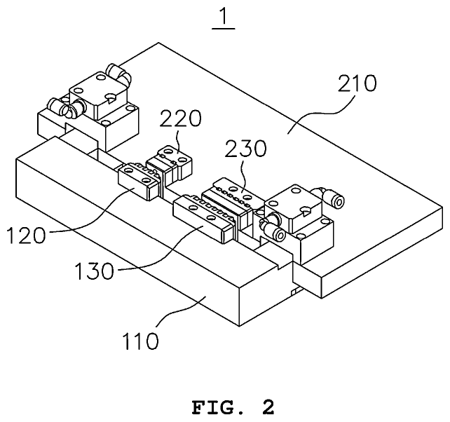

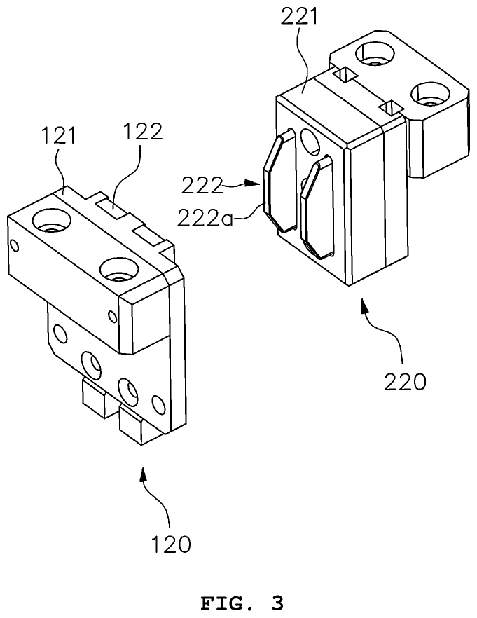

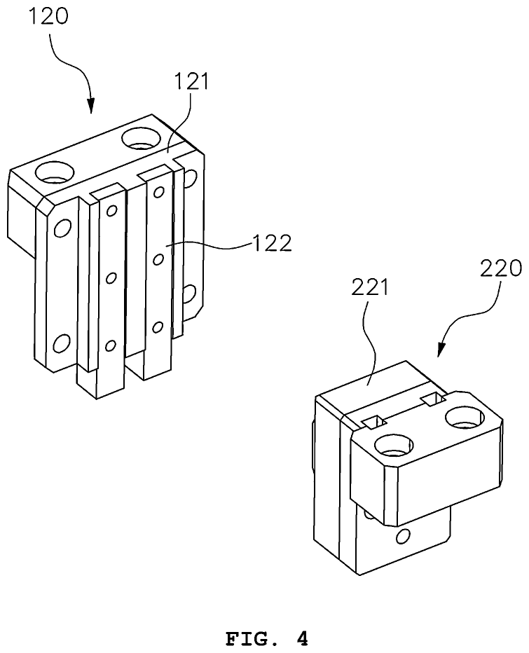

FIG. 1 and FIG. 2 are perspective views respectively illustrating a separated state and a connected state of an electrical connector for supplying a utility according to an embodiment of the present disclosure, and FIG. 3 and FIG. 4 are perspective views illustrating only terminals of the electrical connector for supplying the utility according to an embodiment of the present disclosure.

Referring to FIG. 1 to FIG. 4, an electrical connector 1 for supplying a utility according to an embodiment of the present disclosure includes a first coupling member 110, a first terminal 120, a second coupling member 210, and a second terminal 220.

The first coupling member 110 and the second coupling member 210 are respectively provided at a utility supplying end and a utility receiving end, and may respectively include coupling guide members in male and female forms. In the present embodiment, as the coupling guide members, a guide arm 111 that protrudes in a coupling direction from the first coupling member 110 and a guide groove 211 which is formed in the second coupling member 210 corresponding to the guide arm 111 and into which the guide arm 111 is inserted are illustrated. Such coupling guide members may be modified in various forms within a range in which the first coupling member 110 and the second coupling member 210 are capable of being coupled to each other. Meanwhile, although not illustrated, a separate locking member capable of mechanically fixing or releasing a coupling state of the first coupling member 110 and the second coupling member 210 may be added. Reference numeral 240 indicates a coupler which is provided on the second coupling member 210 and to which a pneumatic utility is supplied.

The first terminal 120 is a terminal provided at the first coupling member 110 and is configured to supply power to the utility receiving end, and may include a terminal mold 121 fixed to the first coupling member 110 and a terminal bar 122 fixed to the terminal mold 121. The terminal mold 121 may be provided as a well-known insulation material for electrically insulating an adjacent terminal bar.

In the present embodiment, as the terminals, a power terminal unit for supplying a power utility and a signal terminal unit for inputting and outputting a detection signal of a sensor are illustrated. Furthermore, two terminals respectively provided at the first terminal 120 and the second terminal 220 and used as a power terminal unit for direct current are illustrated, and the power terminal unit may be a power terminal unit for alternating current.

The signal terminal unit is arranged in a line with and adjacent to the power terminal unit, and is configured as a third terminal 130 provided at the first coupling member 110 and a fourth terminal 230 provided at the second coupling member 210. Furthermore, only the number of terminals is different, but the first terminal 120 and the third terminal 130 are the same and the second terminal 220 and the fourth terminal 230 are the same. In the embodiment, as the fourth terminal 230 constituting the signal terminal unit, two terminal plates 231 for a power of the sensor and four terminal plates 232 for a signal of the sensor are illustrated. The third terminal 130 corresponds to the fourth terminal 230 and is provided with terminal bars having the same number. The number of terminals of such a signal terminal unit may be increased or decreased.

As described above, such a signal terminal unit is the same as the power terminal unit except for the number of terminals. Therefore, hereinafter, the first terminal unit 120 and the second terminal unit 220 will be mainly described without distinguishing the power terminal unit and the signal terminal unit.

Preferably, the third terminal 220 includes a housing 221 fixed to the second coupling member 210, a terminal plate 222 configured to move back and forth within the housing 221 in the coupling direction of the first coupling member 110 and the second coupling member 210, and an elastic body elastically supporting the terminal plate 222 the housing 221. Preferably, the terminal plate 222 includes a tip edge 222a provided at a tip portion of the terminal plate 222, the tip edge 222a being configured to be in line contact with the terminal bar 122.

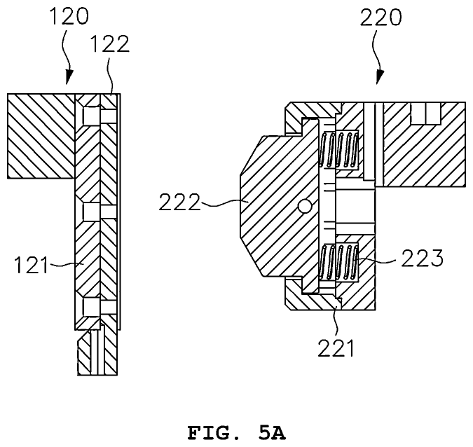

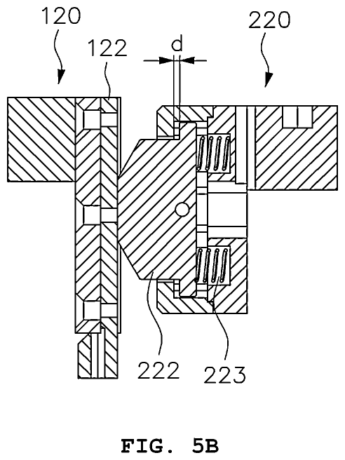

FIG. 5A and FIG. 5B are cross-sectional views illustrating an operation state of the electric connector for supplying the utility according to an embodiment of the present disclosure. FIG. 5A illustrates a separated state and FIG. 5B illustrates a connected state.

Referring to FIG. 5A and FIG. 5B, as the first coupling member 110 and the second coupling member 210 are connected to each other, the first terminal 120 and the second terminal 220 are in contact with each other and are electrically connected to each other. Specifically, the terminal plate 222 is elastically supported by the elastic body 223 and is in contact with the terminal bar 121, and a state in which the terminal plate 222 and the terminal bar 121 are stably in contact with each other may be maintained by the elastic body 223 which is compressed by a predetermined length d and which is elastically supporting the terminal plate 222 and the terminal bar 121.

The specific embodiment of the present disclosure is described in detail above. However, the present disclosure is not limited to the specific embodiment. It would be apparent to a person of ordinary skill in the art that various modifications to the present disclosure are possible within the scope of the technical idea of the present disclosure.

What is claimed is:

1. An electrical connector for supplying a utility, the electrical connector comprising:
a first coupling member provided on any one of a utility supplying end or a utility receiving end;
a first terminal provided on the first coupling member;
a second coupling member provided on other one of the utility supplying end or the utility receiving end and configured to be coupled to the first coupling member; and
a second terminal provided on the second coupling member and configured to be elastically in contact with the first terminal.

2. The electrical connector of claim 1, wherein the second terminal comprises:
a housing fixed to the second coupling member;
a terminal plate formed in a plate shape and configured to move back and forth within the housing in a coupling direction of the first coupling member and the second coupling member; and
an elastic body elastically supporting the terminal plate the housing.

3. The electrical connector of claim 1, wherein the first terminal comprises:
a terminal mold fixed to the first coupling member; and
a terminal bar fixed to the terminal mold.

4. The electrical connector of claim 1, wherein the first terminal and the second terminal comprise:
a power terminal unit for supplying power; and
a signal terminal unit for inputting and outputting a detection signal of a sensor.

5. The electrical connector of claim 1, wherein the first coupling member and the second coupling member further comprise respective coupling guide members for male-female coupling.
